(19) United States
(12) Patent Application Publication
(10) Pub. No.: US 2026/0331947 A1
(43) Pub. Date: Oct. 22, 2026

(54) HIGH-VOLTAGE BATTERY SYSTEM

(71) Applicant: ELRINGKLINGER AG, Dettingen/Erms (DE)

(72) Inventors: Simon Stiefel, Dettingen/Erms (DE); Stefan Hornauer, Dettingen/Erms (DE); Lars Weller, Dettingen/Erms (DE)

(21) Appl. No.: 19/112,392

(22) PCT Filed: Aug. 31, 2023
(86) PCT No.: PCT/EP2023/073976

§ 371 Date: Mar. 17, 2025

(30) Foreign Application Priority Data
Sep. 16, 2022 (DE) 10 2022 123 866.0

(51) Int. Cl. H02J 13/183; H02J 7/50; H02J 7/60; H02J 7/62; H02J 7/80; H02J 13/13

(52) U.S. Cl. CPC H02J 13/183; H02J 7/50; H02J 7/62; H02J 7/663; H02J 7/80; H02J 13/1317

(57) ABSTRACT

A high-voltage battery system for storing electrical energy in a number of electrically interconnected elementary storage cells, which are monitored and controlled by a battery management system via an analog line and/or a data line, and has an electrical connection of the interconnected elementary storage cells to external high-voltage connections via high-voltage paths with circuit breakers in a high-voltage distribution box. The high-voltage battery system includes a base system having at least one node to an essentially electrically identical subsystem, wherein the node is embodied as an interface for an analog line and/or a data line of the subsystem to the battery management system of the base system and as an interface for a high-voltage path of the subsystem, and wherein the subsystem itself comprises essentially only interconnected modules.

### FIELD OF THE INVENTION

The present invention relates to a high-voltage battery system for storing electrical energy in a number of interconnected elementary storage cells that are monitored and controlled by means of a battery management system, with electrical connection of the interconnected elementary storage cells to external high-voltage connections via circuit breakers in a high-voltage distribution box.

### BACKGROUND OF THE INVENTION

Various approaches to constructing a high-voltage battery system of this type are known from the prior art, which in the case of very high capacities, are specified as stationary systems.

Most high-voltage battery systems are housed in a container and have a gateway that controls parallel-connected sub-battery systems. This has the disadvantage that conventional high-voltage battery systems are very massive, heavy, and unwieldy to transport and assemble. At the same time, there is increasing demand for stationary high-voltage battery storage systems for grid stability or for use as emergency power supplies of different sizes and electrical capacities. There are currently few scalable applications for such stationary high-voltage energy storage systems with high capacities. Without suitable new development, it is therefore necessary to fall back on standard sizes.

The object of the present invention is to produce a high-voltage battery system that is easier to transport and assemble and has adaptable capacity.

### SUMMARY OF THE INVENTION

In a high-voltage battery system that is for storing electrical energy in a number of interconnected elementary storage cells, which are connected via an analog line and/or a data line and are monitored and controlled by means of a battery management system, and has an electrical connection of the interconnected elementary storage cells to external high-voltage connections via high-voltage paths with circuit breakers in a high-voltage distribution box, this object is attained according to the invention by a high-voltage battery system that comprises a base system in which at least one node to an essentially electrically similar subsystem is provided, which is embodied as an interface for an analog line and/or a data line of the subsystem to the battery management system and as a connection for a high-voltage path of the subsystem, and a subsystem itself essentially comprises interconnected modules, only. This makes it easier to adapt the total capacity of a high-voltage battery system in a scaled manner by means of a number of subsystems in fixed step sizes. This adaptation of a total capacity of a high-voltage battery system according to the invention can be carried out by connecting one or more subsystems to the node in the base system while having a reduced number of battery management systems.

The present invention is based on the realization that in high-voltage battery systems as well, a scalability achieved through the connection of at least one subsystem also significantly simplifies the mechanical requirements for transport, assembly, and on-site installation of a high-voltage battery system composed of multiple units. The base system constitutes a first unit and is able to operate on its own as a high-voltage battery system with a specific electrical capacity and power. A subsystem that is essentially electrically similar to this base system, preferably embodied in the form of a standardized module, simplifies the scalability of a high-voltage battery system according to the invention in both respects: systems with essentially similar electrical properties are also constructed in essentially the same way and require essentially the same amount of space and the same operating conditions. This is a significant advantage for the selection of electrical components, but also with regard to mechanical anchoring and cooling. At the same time, however, a subsystem also accesses resources of the base system that are not present in the subsystem: the subsystem is connected to the battery management system of the base system via an interface for an analog line and/or a data line. The subsystem therefore does not have its own separate battery management system among other things. The subsystem can also be monitored and controlled by the battery management system of the base system thanks to the established electrical similarity and the interconnection of elementary storage cells of the base system. The subsystem can therefore be regarded as a passive system, at least from a control standpoint, while the base system can be regarded as an active system. The at least one subsystem can be positioned spatially apart from the base system so that in a preferred embodiment of the invention, a distributed structure of at least one base system and at least one subsystem electrically connected thereto is obtained.

In an advantageous modification of the invention, the node is provided in the region of the high-voltage distribution box of the base system. Thus without a lot of effort, the high-voltage distribution box is also embodied as the center of various interfaces.

In an advantageous modification of the invention, the interface for the high-voltage path of the subsystem is embodied as a parallel circuit. The electrical similarity of the base system to the at least one subsystem therefore at least lies in a common voltage level in the region of the node.

In a modification of the high-voltage battery system according to the invention, a current measuring point is provided in the high-voltage path of the subsystem, which in one exemplary embodiment of the invention is positioned upstream of the node. Preferably, the current measuring point is embodied as a low-loss compact Hall sensor.

In an advantageous modification of the invention, the interface for the high-voltage path and/or the analog line and/or the data line of the subsystem is embodied as a connector in the node.

The interface for the high-voltage path and/or the analog line and/or the data line of the subsystem in the node is preferably embodied as an electromechanical connection with a connector.

In an advantageous modification, the connector of the subsystem comprises the interface of the high-voltage path and the low-voltage path in a shared housing. This provides a safe and compact design for a reliable electrical connection of the subsystem to the node of the base system.

In a preferred modification, a device according to the invention has an advantageous securing means such that the connector of the subsystem comprises a switch that allows the connector of the high-voltage path to produce a connection only if the node is anchored in a mechanically secured way.

Preferably, a high-voltage battery system according to the invention comprises a subsystem with a series connection of elementary storage cells, contactors as switches in the high-voltage path, a fuse, and preferably an economizer for the internal coil current control of the contactors as an alternative to external pulse-width modulation or PWM control.

In a modification of the invention, a low-voltage supply of circuit breakers or contactors of the subsystem is routed via the switch in the connector of the high-voltage path. This ensures that a high-voltage connector is in a currentless and potential-free state until there is a mechanically secure electrical connection between the connectors in the node.

### BRIEF DESCRIPTION OF DRAWINGS

Other features and advantages of embodiments according to the invention are explained in greater detail below with reference to exemplary embodiments shown in the drawings. In schematic depictions:

FIG. 1: shows a circuit diagram of a first exemplary embodiment of a high-voltage battery system as a base system with at least one node;

FIG. 2: shows a circuit diagram of a second exemplary embodiment of a high-voltage battery system as a base system with a node comprising two interfaces;

FIG. 3: shows a circuit diagram of an exemplary embodiment of a subsystem, and

FIG. 4: shows a block diagram of an exemplary embodiment of a scalable, expandable high-voltage battery system using base systems and subsystems connected thereto.

### DETAILED DESCRIPTION OF THE INVENTION

The same reference symbols are consistently used for the same elements or process steps throughout the various figures. Without limiting the invention, only one application of a high-voltage battery system is illustrated and described below, which is particularly embodied for stationary use as an emergency power system or large-capacity equalizing storage system. It is, however, clear to the person skilled in the art that an adaptation to the use of distributed energy storage in a land vehicle, watercraft, or aircraft is also possible in the same way, in particular using a cell-to-chassis approach.

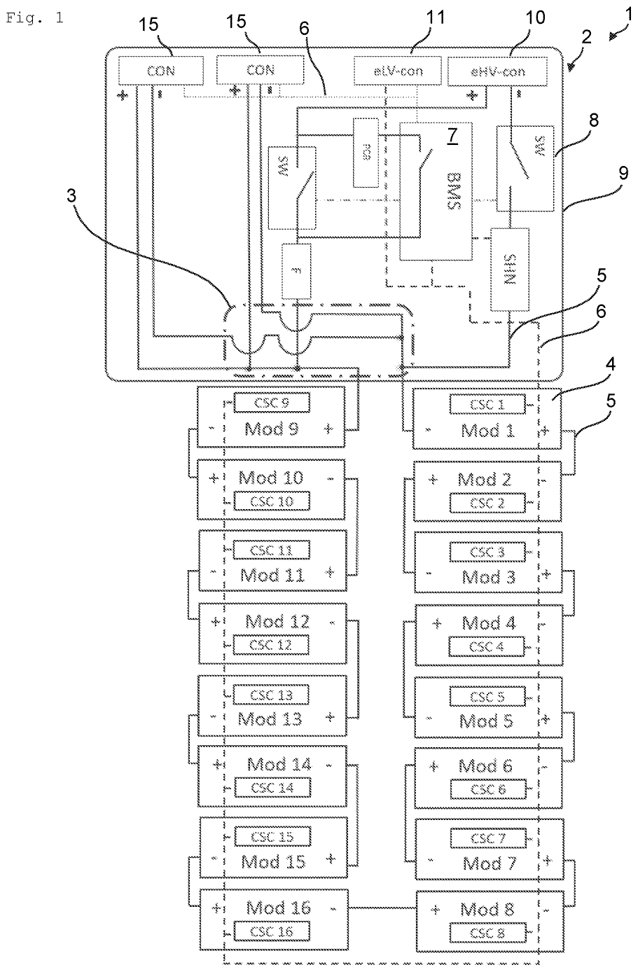

FIG. 1 shows a circuit diagram of a first exemplary embodiment of a high-voltage battery system 1 as a base system 2 with at least one node 3. The high-voltage battery system 1 is embodied to store electrical energy in a number of electrically interconnected elementary electrochemical storage cells 4, preferably lithium-ion cells of cylindrical design, which are interconnected in the form of modules Mod in this exemplary embodiment. In this instance, 16 modules Mod are connected to one another in a series circuit. Each of the modules Mod is assigned its own cell monitoring circuit csc, as indicated by their matched numbering. The cell monitoring circuit csc continuously uses various sensors to monitor the respective module Mod in order to generate corresponding measurement and status data based thereon. Building on this data from the cell monitoring circuits csc, a higher-level control and regulation of the above-described electrochemical storage apparatus takes place in a battery management system 7 or BMS for short. The modules Mod have an analog line 5 for transmitting electrical power and a data line 6 for transmitting control and monitoring data to the battery management system 7, implemented here in the form of a reversible isoSPI data line. The analog line 5 is embodied as an electrical connection of the modules Mod composed of interconnected elementary storage cells 4 as a high-voltage path, which extends to an external high-voltage connection eHV con 10 for both polarities via circuit breakers 8 in a high-voltage distribution box 9.

In addition to the battery management system 7, which is operated at a low-voltage level of 12 V, the high-voltage distribution box 9 also comprises the circuit breakers 8, which are connected to the battery management system 7 via an analog control line and are provided for each polarity, essentially also a fuse F, and a current measuring resistor SNT, which in turn is connected to the battery management system 7 via a reversible isoSPI data line 6. From the battery management system 7, the data line 6 at the high-voltage distribution box 9 extends to an external low-voltage connection eLV con 11 of the isoSPI bus.

The system that is described above and is known from the prior art is now expanded as a base system 2 for a scalable expansion of an electrical capacity by means of at least one node 3 on the high-voltage path 5, to which at least one essentially electrically similar subsystem 12 is connected. The node 3 is provided in the region of the high-voltage distribution box 9 and as a connection, has a connector 13 for a high-voltage path 5 of the subsystem 12 on the low-voltage level and also an interface for the data line 6 of the subsystem 12 to the battery management system 7 of the base system 2, as described in greater detail below.

In the present exemplary embodiment, the interface for connecting a high-voltage path 6 of the subsystem 12 to the high-voltage path 6 of the base system 2 is connected as a parallel circuit in the node 3 via high-voltage connectors 13. Therefore in the present exemplary embodiment, two subsystems 12 can be connected to or plugged into the base system 2 in the region of node 3 in a parallel circuit.

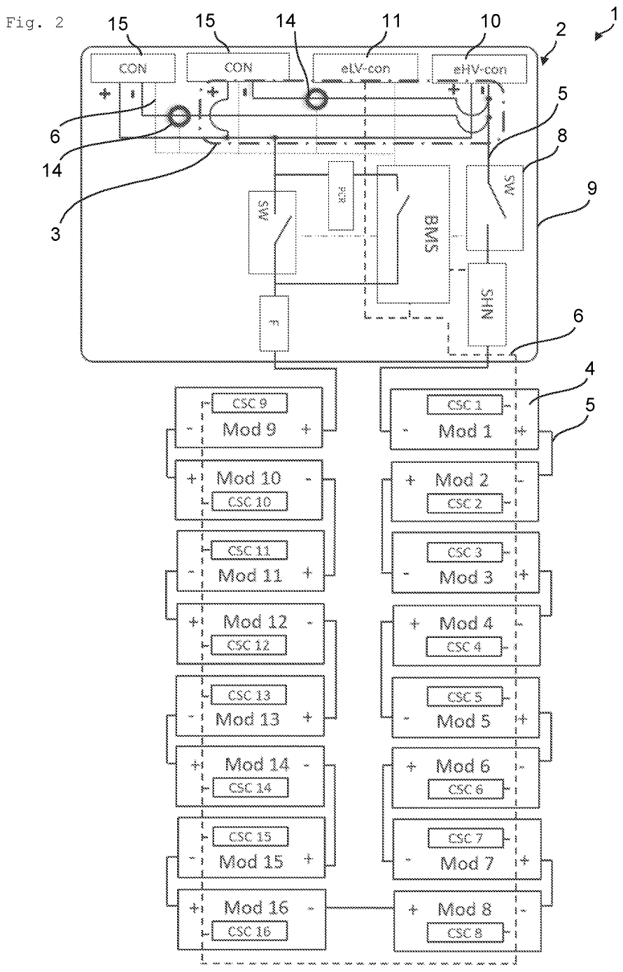

FIG. 2 shows a circuit diagram of a second exemplary embodiment of a high-voltage battery system as a base system 2 with a node 3 comprising two interfaces or connectors 13. In an extension of the first exemplary embodiment, a current measuring point 14 is now provided in the high-voltage path 5 of the base system 12. To measure the individual phase currents, the current measuring point 14 is positioned upstream of the node 3 and is respectively embodied as a Hall sensor. This allows the current flow in each of the up to two subsystems 12 to be determined separately. This measurement data is transmitted to the battery management system 7 via a CAN, KI15, or KI30C data line 6 and is also forwarded to higher instances via a low-voltage connector eLV-con of the high-voltage distribution box 7. A vehicle control unit VCU thus communicates in a way that is not shown in greater detail with the battery management system 7 of the base system 2 and, via this battery management system 7, also with the subsystems 12 that are connected to the base system 2 via the node 3. The elimination of separate battery management systems 7 in the subsystems 12 leads to significant cost savings, but limits the number of subsystems 12 that can be connected to a base system 2 to two in the present example. For this reason, no further connections for additional parallel circuits can be provided in the node 3.

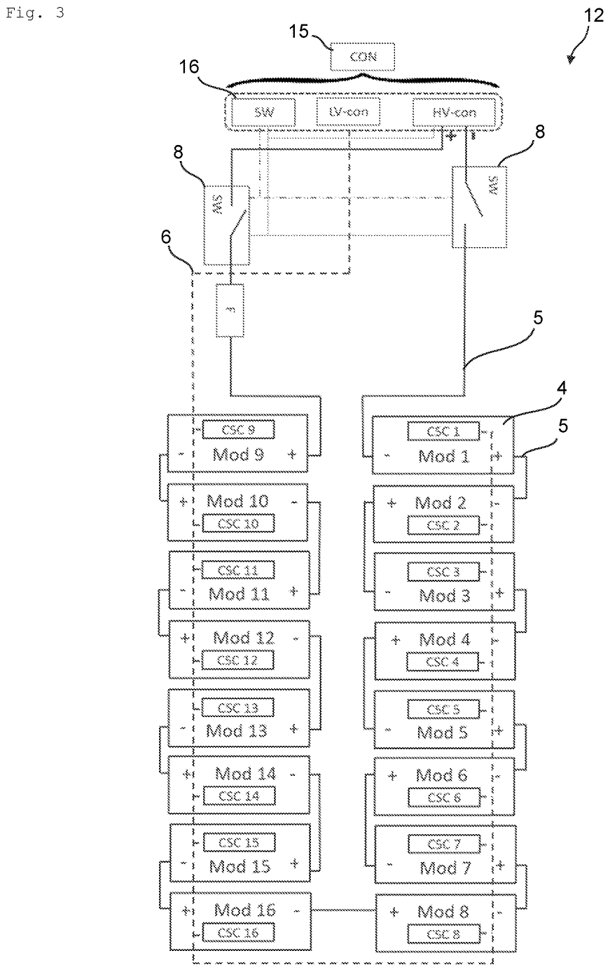

FIG. 3 shows a circuit diagram of an exemplary embodiment of a subsystem 12. The subsystem 12 itself essentially comprises only a series connection of 16 modules and thus corresponds to one of the base systems 2 described above in terms of its electrical properties. In terms of monitoring and control, however, the subsystem 12 is a passive system since it does not comprise its own battery management system BMS, but is instead monitored and controlled by means of the battery management system BMS of a base system 2 to which it is assigned by being connected to it. The high-voltage paths 5 have only one fuse F and two circuit breakers SW. In this exemplary embodiment, a connector 15 of the subsystem 12 in a housing comprises an interface for the high-voltage path 5 and the low-voltage path 6. The connector 15 of the subsystem 12 comprises a switch 16, which is embodied so that it allows the high-voltage path 5 to be connected only if the connector 15 is anchored to the connector 13 of the node 3 in a mechanically secured way. As a safeguard, a low-voltage supply of contactors SW of the subsystem 12 is routed via the switch 16 in the connector 15. Each subsystem 12 itself therefore essentially comprises only interconnected modules Mod and thus constitutes a pure expansion of an electrical storage capacity without having its own control and monitoring functionalities. While being essentially the same size as a base system 2, subsystems 12 are therefore also comparatively cheaper than base systems 2.

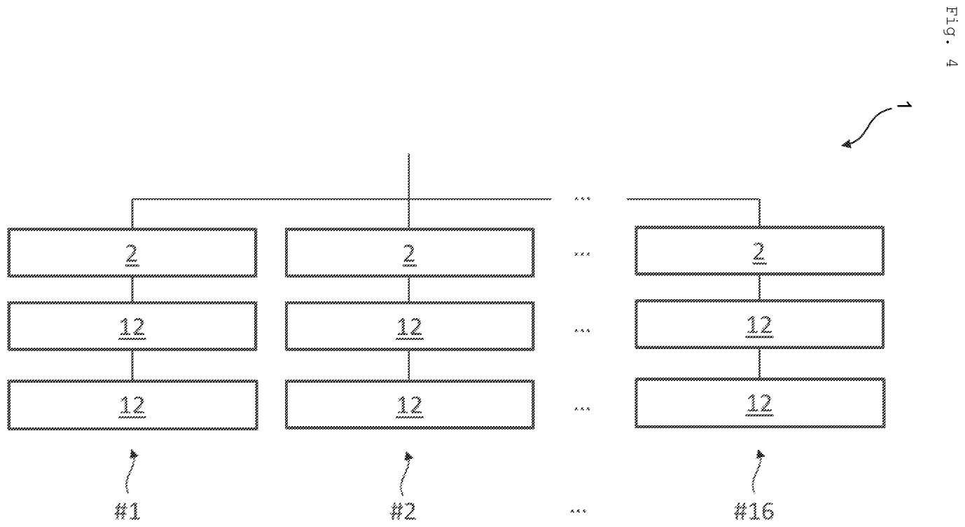

FIG. 4 shows a block diagram of an exemplary embodiment of a high-voltage battery system 1 that is scalable and can therefore be flexibly expanded to meet a particular requirement. Up to now, it has been known to series-connect and/or parallel-connect parts that match the respective multiple base systems 2 in terms of their number. Now, the above-described nodes 3 can be used to expand each of the base systems 2 by one or two parallel-connected subsystems 12 for purposes of a step-by-step or scalable expansion of an electrical capacity of the high-voltage battery system 1. Using base systems 2 and up to two subsystems 12 connected thereto, the above-outlined high-voltage battery system 1 can thus be expanded in partial steps in the relevant base systems 2 as well, without requiring additional circuit complexity and/or adaptation effort. In this exemplary embodiment, a maximum expansion stage of a high-voltage battery system 1 is achieved with 16 base systems 2 shown as rows #1 to #16, each with two subsystems 12 connected to it. This means that in an overall system composed of (1+2)*16=48 units that have the same electrical storage behavior as one another, up to 16 elementary electrochemical storage cells 4 can be connected in series in each. In the above-outlined maximum expansion stage, however, this overall apparatus is reliably monitored and controlled by limiting it to 16 battery management systems 7.

A high-voltage battery system has thus been described above, which is easier to transport and assemble compared to known devices and has a total capacity that can be adjusted by scaling in the form of subsystems 12. Furthermore, according to a form according to the invention, stationary high-voltage energy storage systems with high capacities can be constructed more flexibly with easier handling of subsystems due to their different positioning. At the same time, using the control and monitoring functionalities of a respectively associated base system 2 with safe and reliable interconnection via the node 3 reduces the complexity of the subsystems 12 at least by eliminating the need for separate battery management systems.

1. A high-voltage battery system for storing electrical energy in a plurality of electrically interconnected elementary storage cells, which are connected via an analog line and/or a data line with monitoring and control by means of a battery management system, and has an electrical connection of the interconnected elementary storage cells to external high-voltage connections via high-voltage paths with circuit breakers in a high-voltage distribution box
the high-voltage battery system comprises:
a base system
at least one node to an electrically similar subsystem provided in the base system,
wherein the at least one node is embodied as an interface for an analog line and/or a data line of the subsystem to the battery management system of the base system and as an interface for a high-voltage path of the subsystem and wherein the subsystem itself comprises only interconnected modules.

2. The high-voltage battery system according to claim 1, wherein the at least one node is provided in a region of the high-voltage distribution box.

3. The high-voltage battery system according to claim 1, wherein the interface for the high-voltage path of the subsystem in the base system is embodied as a parallel circuit.

4. The high-voltage battery system according to claim 1, wherein a current measuring point is provided in the high-voltage path of the base system.

5. The high-voltage battery system according to claim 4, wherein the current measuring point is positioned upstream of the at least one node.

6. The high-voltage battery system according to claim 4, wherein the current measuring point is embodied as a Hall sensor.

7. The high-voltage battery system according to claim 1, wherein the interface for the high-voltage path and/or the analog line and/or the data line of the subsystem in the at least one node is embodied as an electromechanical connection with a connector.

8. The high-voltage battery system according to claim 7, wherein the connector of the subsystem comprises a high-voltage path and a low-voltage path for a data line in a shared housing.

9. The high-voltage battery system according to claim 7, wherein the connector of the subsystem comprises a switch that allows the connector to connect only if the high-voltage path is anchored to the at least one node in a mechanically secured way.

10. The high-voltage battery system according to claim 9, wherein the subsystem comprises a series connection of elementary storage cells, contactors as circuit breakers in the high-voltage path and a fuse (F).

11. The high-voltage battery system according to the claim 10, wherein the subsystem comprises an economizer.

12. The high-voltage battery system according to preceding claim 11, wherein a low-voltage supply of circuit breakers of the subsystem is routed via the switch in the connector of the high-voltage path.
